(19) United States
(12) Patent Application Publication
(10) Pub. No.: US 2026/0362349 A1
(43) Pub. Date: Nov. 12, 2026

(54) PROXIMITY ENHANCEMENT FOR NON-TERRESTRIAL NETWORK (NTN) USER EQUIPMENT (UE)

(71) Applicant: Apple Inc., Cupertino, CA (US)

(72) Inventors: Jie Cui, San Jose, CA (US); Yang Tang, San Jose, CA (US); Dawei Zhang, Saratoga, CA (US); Qiming Li, Beijing (CN); Chunxuan Ye, San Diego, CA (US); Fangli Xu, Beijing (CN); Hong He, San Jose, CA (US); Xiang Chen, Campbell, CA (US); Manasa Raghaven, Sunnyvale, CA (US)

(21) Appl. No.: 18/997,019

(22) PCT Filed: Jul. 27, 2023
(86) PCT No.: PCT/US23/28780

§ 371 Date: Jan. 18, 2025

Related U.S. Application Data
(60) Provisional application No. 63/396,248, filed on Aug. 9, 2022.

(51) Int. Cl. H04W 56/00; H04W 84/06

(52) U.S. Cl. CPC H04W 56/001; H04W 84/06

(57) ABSTRACT

A user equipment (UE), including a non-terrestrial network (NTN) UE, a baseband processor or other network device can operate in a new radio (NR) unlicensed network to (pre)determine whether a collision or overlap occurs between a first set of synchronization signal (SS)/physical block channel (PBCH) block (SSB) measurement timing configuration (SMTC) occasions and a second set of SMTC occasions based on a proximity threshold of a proximity distance. In response to determining that the collision occurs, the UE or other component can measure one of: the first set of SMTC occasions or the second set of SMTC occasions, otherwise measure the first set of SMTC occasions and the second set of SMTC occasions where there no collision or overlap. The threshold can be based on different SMTCs, associated with one or more measurement gaps or not.

### REFERENCE TO RELATED APPLICATIONS

This Application claims the benefit of U.S. Provisional Application No. 63/396,248, filed on Aug. 9, 2022 the contents of which are hereby incorporated by reference in their entirety

### FIELD

The present disclosure relates to wireless technology, and, pertains to enhancements in proximity for non-terrestrial network (NTN) user equipment (UE).

### BACKGROUND

As the number of mobile devices within wireless networks, and the demand for mobile data traffic, continue to increase, changes are made to system requirements and architectures to better address current and anticipated demands. For example, some wireless communication networks (e.g., fifth generation (5G) or new radio (NR) networks) may be developed to include non-terrestrial networks (NTN) comprising one or more satellites. In such scenarios, the satellites may operate as transparent network nodes linking user equipment (UEs) with a ground-based portions of the network, such as base stations and core network (CN).

### BRIEF DESCRIPTION OF THE DRAWINGS

FIG. 1 illustrates an exemplary block diagram illustrating an example of user equipment(s) (UEs) communicatively coupled a network with network components as peer devices useable in connection with various embodiments (aspects) described herein..

FIG. 2 illustrates an example simplified block diagram of a user equipment (UE) wireless communication device or other network device/component (e.g., eNB, gNB) in accordance with various aspects.

FIG. 3 illustrates an example of pre-determining a collision or overlap for measuring resources in a network in accordance with various aspects.

FIG. 4 illustrates another example of processes in determining a collision or overlap for measuring resources in a network in accordance with various aspects.

FIG. 5 illustrates another example of processes in determining a collision or overlap for resources in a network in accordance with various aspects.

FIG. 6 illustrates another example of processes in determining a collision or overlap for resources in a network in accordance with various aspects.

FIG. 7 illustrates another example of processes in determining a collision or overlap for resources in a network in accordance with various aspects.

FIG. 8 illustrates another example of processes in determining a collision or overlap for resources in a network in accordance with various aspects.

FIG. 9 illustrates another example of processes in determining a collision or overlap for resources in a network in accordance with various aspects.

FIG. 10 illustrates another example of processes in determining a collision or overlap for resources in a network in accordance with various aspects.

FIG. 11 illustrates an example of process flow for determining a collision or overlap for resources in a network in accordance with various aspects.

FIG. 12 illustrates a diagram illustrating example components of a device that can be employed in accordance with various aspects discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Various aspects include a user equipment (UE) operating radio resource management (RRM) measurement procedures in 5G new radio (NR). In particular, RRM processes can include (pre)determining a collision (or, overlap) between proximate configuration resources received for measuring. In long term evolution (LTE) protocols, the base station continually transmits a cell-specific reference signal (CRS), making it easier for the UE to measure the cell quality of neighboring cells. In 5G NR, at least some aspects of CRS are removed to reduce the overhead and reference signal interference from other cells. In contrast to the continual transmission of CRS in some releases of LTE, in 5G NR, cell signal measurement is performed by using a synchronization signal (SS)/physical broadcast channel (PBCH) block (SSB) burst that includes SSBs to be measured. The number of SSBs in one SSB burst depends on the operating frequency. For example, if the operating frequency (fc) is <3 GHz (FR1) the number of SSBs can be 4; for fc=3 GHz to 6 GHz (FR1) the number of SSBs can be 8; and for fc>6 GHz mm-wave, the number of SSBs can be 64 within one burst. These multiple SSBs can be associated with different SSB indexes and different transmission beams, which can be configured for beam management and measurement. The RRM measurement procedure may include a procedure that is performed to reduce UE power consumption. In particular, a collision or overlap between configuration resources can be determined, which may then reduce unnecessary measurements and power consumption of a UE by enabling the UE to not have to measure other SSBs outside of an SMTC window depending on the determination result.

5G NR has introduced SSB based measurement timing configurations (SMTCs). An SMTC defines an SMTC window or SMTC occasion, as well as a periodicity that can be used to restrict the UE measurements on certain resources. Within the SMTC window/SMTC occasion and on the configured SSB, the UE conducts the Radio Link Monitoring (RLM)/RRM measurement according to the measurement periodicity and the timing of the SSBs. The SSBs and SMTC windows (occasions) can be configured differently for each cell or each frequency layer in order to avoid unnecessary measurements and reduce the power consumption of a UE.

In particular, the SMTC window periodicity could be set in a same range of the SSBs (e.g., 5, 10, 20, 40, 80 or 160 ms) and an SMTC window duration can be set to 1, 2, 3, 4, or 5 ms, for example, based on the number of SSBs transmitted on a cell being measured. Thus, different cells can be measured with a different window periodicity and a different window duration. When the UE has been notified of the parameters of an SMTC window by the base station, the UE detects and measures the SSBs within that SMTC window (or occasion) and reports the measurement results back to the base station. Because the UE does not measure any SSBs outside of the SMTC window, unnecessary measurements are avoided and power consumption is able to be reduced by not monitoring or measuring outside of configured occasions.

One consideration of the UE during RRM processes includes (pre)determining whether measurement gaps or SMTC occasions are overlapping or colliding. The time duration that a UE suspends communication with the serving cell to measure an inter-frequency neighbor or other radio access technology (RAT) neighbor can be referred to as a measurement gap (MG). If MGs are considered to be overlapping, then the UE only measures within one MG from among the MGs and in a one-time instance or SMTC occasion; other periods are then used to capture the other measurement occasions not realized. If MGs are not overlapping, then the UE can measure each measurement gap or SMTC occasion within a single periodicity, thereby also avoiding unnecessary measurement at a further time and reducing power consumption.

In one example, two MG occasions can be defined as colliding (or, overlapping) if the two measurement gap occasions are at least partially overlapping in a time domain, or if a minimum distance between them is equal or less than a proximity distance (e.g., about 4 ms, or the other duration). Additionally, two SMTC occasions in parallel or concurrent to one another can be defined as colliding (overlapping) when these two SMTCs are at least partially overlapping in a time domain, or when the minimum distance is less than or equal to a threshold proximity distance (e.g., about 3 ms, 4 ms, or other duration).

Collision between occasions of SMTC and measurement gap (e.g., for a satellite access node (SAN) or other node) may also occur. For example, when a UE is configured with one or more than one measurement gap pattern, an SMTC occasion outside measurement gap and a measurement gap occasion are considered colliding if at least one of the following conditions is met: a) the SMTC occasion is fully or partially overlapping in time domain with the measurement gap occasion, or b) the magnitude of the distance between the SMTC occasion and the measurement gap occasion in time domain is less than or equals to 4 ms. The distance between a SMTC occasion and a measurement gap occasion can be defined as: i. the time difference between the ending point of the SMTC occasion and the starting point of the measurement gap (or measurement gap occasion), where the SMTC occasion occurs earlier in time than the MG occasion, or ii. the time difference between the ending point of the measurement gap occasion and the starting point of the SMTC occasion, where the measurement gap occasion occurs earlier in time than the SMTC occasion.

In an aspect, a UE can receive notification of at least one first SMTC occasion and at least one second SMTC occasion for measuring resources. Then the UE can determine whether a collision occurs between the at least one first SMTC occasion and the at least one second SMTC occasion based on a proximity threshold of a proximity distance that is between MGs, or based on an SMTC proximity distance threshold of an SMTC proximity distance between different SMTC occasions (whether in a same or different measurement gaps), or between an SMTC occasion and a separate measurement gap (MG occasion) that is earlier or later in time relative to the SMTC. If a collision is determined to occur, based on a proximity distance threshold, prior to performing RRM measuring, the UE could then measure one MG or SMTC; otherwise, if a collision is not (pre)determined to occur, the UE is able to measure both MGs or SMTC occasions.

A proximity distance threshold of a proximity distance can be referred to as a distance between different MGs, between a measurement gap and one or more SMTCs, or between different SMTCs. An MG proximity distance threshold can refer to a proximity distance threshold between different MGs, and an SMTC proximity distance threshold can refer to a proximity distance between SMTCs, for example.

In various aspects, SMTC occasions may be associated with different measurement gaps, or be without an associated MG. As such, various aspects herein address determining collision or overlap among different MGs with associated SMTCs, and between SMTCs without an association to an MG and those associated with an MG for RRM measuring. Additionally, various proximity distance thresholds can be utilized for different collision determinations: an MG proximity distance threshold between MGs, an SMTC proximity distance threshold between SMTCs, or a proximity distance threshold between an MG and one or more SMTCs.

In an aspect, an SMTC proximity distance threshold can be an amount of an MG proximity distance threshold and either twice times a radio frequency (RF) tuning/retuning time, or one RF tuning/retuning time. For example, the MG proximity distance threshold could be about 4 ms or other time, and each RF tuning/retuning time be about 1 ms or other time to include processing time by the UE's capability. Various other aspects can include enhancements for determining proximity between the MGs or SMTC occasions by a UE, such as for UE of a non-terrestrial network (NTN), for example. Each of the various aspects herein can provide advantages for avoiding unnecessary measurements and reducing power consumption. Additional aspects and details of the disclosure are further described below with reference to figures.

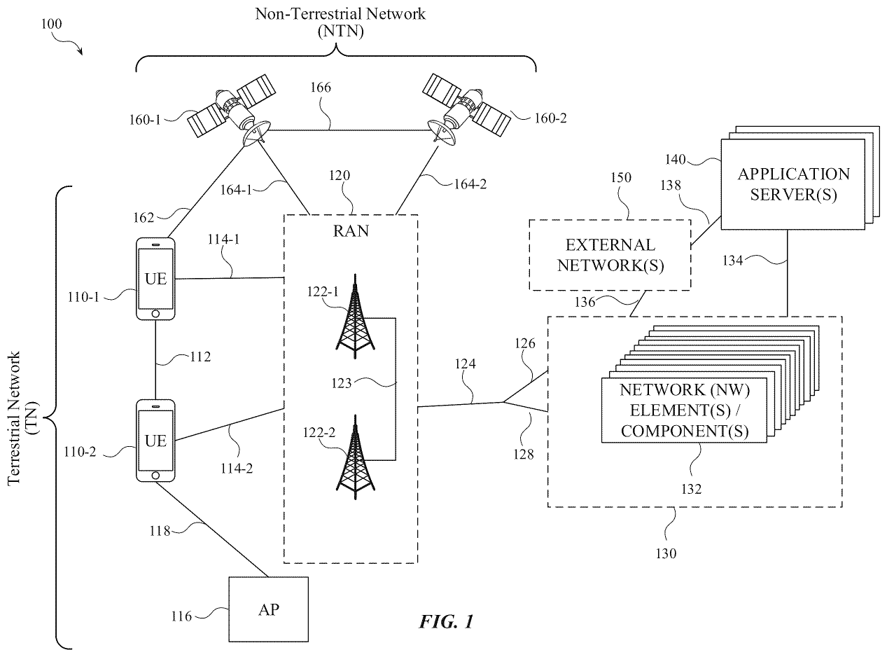

FIG. 1 is an example network 100 according to one or more implementations described herein. Example network 100 can include UEs 110-1, 110-2, etc. (referred to collectively as “UEs 110” and individually as “UE 110”), a radio access network (RAN) 120, a core network (CN) 130, application servers 140, external networks 150, and satellites 160-1, 160-2, etc. (referred to collectively as “satellites 160” and individually as “satellite 160”). As shown, network 100 can include a non-terrestrial network (NTN) comprising one or more satellites 160 (e.g., of a global navigation satellite system (GNSS)) in communication with UEs 110 and RAN 120.

The systems and devices of example network 100 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 100 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 110 can include smartphones (e.g., handheld touchscreen mobile computing devices connectable to one or more wireless communication networks). Additionally, or alternatively, UEs 110 can include other types of mobile or non-mobile computing devices capable of wireless communications, such as personal data assistants (PDAs), pagers, laptop computers, desktop computers, wireless handsets, etc. In some implementations, UEs 110 can include internet of things (IoT) devices (or IoT UEs) that can comprise a network access layer designed for low-power IoT applications utilizing short-lived UE connections. Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Additionally, UEs 110 can be NTN UEs that are capable of being communicatively coupled to satellites 160 in an NTN network.

UEs 110 can communicate and establish a connection with (be communicatively coupled to) RAN 120, which can involve one or more wireless channels 114-1 and 114-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different network nodes (e.g., 122-1 and 122-2) that can be connected via non-ideal backhaul (e.g., where one network node provides NR access and the other network node provides either E-UTRA for LTE or NR access for 5G). In such a scenario, one network node can operate as a master node (MN) and the other as the secondary node (SN). The MN and SN can be connected via a network interface, and at least the MN can be connected to the CN 130. Additionally, at least one of the MN or the SN can be operated with shared spectrum channel access, and functions specified for UE 110 can be used for an integrated access and backhaul mobile termination (IAB-MT). Similar for UE 110, the IAB-MT can access the network using either one network node or using two different nodes with enhanced dual connectivity (EN-DC) architectures, new radio dual connectivity (NR-DC) architectures, or other direct connectivity such as a sidelink (SL) communication channel as an SL interface 112.

In some implementations, a base station (as described herein) can be an example of network node 122. As shown, UE 110 can additionally, or alternatively, connect to access point (AP) 116 via connection interface 118, which can include an air interface enabling UE 110 to communicatively couple with AP 116. AP 116 can comprise a wireless local area network (WLAN), WLAN node, WLAN termination point, etc. The connection 118 can comprise a local wireless connection, such as a connection consistent with any IEEE 702.11 protocol, and AP 116 can comprise a wireless fidelity (Wi-Fi®) router or other AP. AP 116 could be also connected to another network (e.g., the Internet) without connecting to RAN 120 or CN 130.

RAN 120 can also include one or more RAN nodes 122-1 and 122-2 (referred to collectively as RAN nodes 122, and individually as RAN node 122) that enable channels 114-1 and 114-2 to be established between UEs 110 and RAN 120. RAN nodes 122 can include network access points configured to provide radio baseband functions for data or voice connectivity between users and the network based on one or more of the communication technologies described herein (e.g., 2G, 3G, 4G, 5G, WiFi, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 122 can include a roadside unit (RSU), a transmission reception point (TRxP or TRP), and one or more other types of ground stations (e.g., terrestrial access points). In some scenarios, RAN node 122 can be a dedicated physical device, such as a macrocell base station, or a low power (LP) base station for providing femtocells, picocells or other like having smaller coverage areas, smaller user capacity, or higher bandwidth compared to macrocells. As described below, in some implementations, satellites 160 can operate as bases stations (e.g., RAN nodes 122) with respect to UEs 110. As such, references herein to a base station, RAN node 122, etc., can involve implementations where the base station, RAN node 122, etc., is a terrestrial network node and also to implementation where the base station, RAN node 122, etc., is a non-terrestrial network node (e.g., satellite 160).

Some or all of RAN nodes 122 can be implemented as one or more software entities running on server computers as part of a virtual network, which can be referred to as a centralized RAN (CRAN) or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 122; a media access control (MAC)/physical (PHY) layer split wherein RRC, PDCP, radio link control (RLC), and MAC layers can be operated by the CRAN/vBBUP and the PHY layer can be operated by individual RAN nodes 122; or a “lower PHY” split wherein RRC, PDCP, RLC, MAC layers and upper portions of the PHY layer can be operated by the CRAN/vBBUP and lower portions of the PHY layer can be operated by individual RAN nodes 122. This virtualized framework can allow freed-up processor cores of RAN nodes 122 to perform or execute other virtualized applications.

In some implementations, an individual RAN node 122 can represent individual gNB-distributed units (DUs) connected to a gNB-control unit (CU) via individual F1 interfaces. In such implementations, the gNB-DUs can include one or more remote radio heads or radio frequency (RF) front end modules (RFEMs), and the gNB-CU can be operated by a server (not shown) located in RAN 120 or by a server pool (e.g., a group of servers configured to share resources) in a similar manner as the CRAN/vBBUP. Additionally, or alternatively, one or more of RAN nodes 122 can be next generation eNBs (i.e., gNBs) that can provide evolved universal terrestrial radio access (E-UTRA) user plane and control plane protocol terminations toward UEs 110, and that can be connected to a 5G core network (5GC) 130 via an NG interface.

Any of the RAN nodes 122 can terminate an air interface protocol and can be the first point of contact for UEs 110. In some implementations, any of the RAN nodes 122 can fulfill various logical functions for the RAN 120 including, but not limited to, radio network controller (RNC) functions such as radio bearer management, uplink and downlink dynamic radio resource management and data packet scheduling, and mobility management. UEs 110 can be configured to communicate using orthogonal frequency-division multiplexing (OFDM) communication signals with each other or with any of the RAN nodes 122 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations can not be limited in this regard. The OFDM signals can comprise a plurality of orthogonal subcarriers.

Further, RAN nodes 122 can be configured to wirelessly communicate with UEs 110, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum can include channels that operate in a frequency range (e.g., approximately 400 MHz to approximately 3.8 GHz, or other range), whereas the unlicensed spectrum can include about the 5 GHz band or higher, for example. A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity. Whether a particular frequency band corresponds to a licensed medium or an unlicensed medium can depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 110 and the RAN nodes 122 can operate using licensed assisted access (LAA), eLAA, and/or feLAA mechanisms. In these implementations, UEs 110 and the RAN nodes 122 can perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations can be performed according to a listen-before-talk (LBT) protocol or a clear channel assessment (CCA).

A physical downlink shared channel (PDSCH) can carry user data and higher layer signaling to UEs 110. The physical downlink control channel (PDCCH) can carry information about the transport format and resource allocations related to the PDSCH channel, among other things. The PDCCH can also inform UEs 110 about the transport format, resource allocation, and hybrid automatic repeat request (HARQ) information related to the uplink shared channel. Typically, downlink scheduling (e.g., assigning control and shared channel resource blocks to UE 110-2 within a cell) can be performed at any of the RAN nodes 122 based on channel quality information fed back from any of UEs 110. The downlink resource assignment information can be sent on the PDCCH used for (e.g., assigned to) each of UEs 110.

The PDCCH uses control channel elements (CCEs) to convey the control information, wherein a number of CCEs (e.g., 6 or the like) can consists of a resource element groups (REGs), where a REG is defined as a physical resource block (PRB) in an OFDM symbol. Before being mapped to resource elements, the PDCCH complex-valued symbols can first be organized into quadruplets, which can then be permuted using a sub-block interleaver for rate matching, for example. Each PDCCH can be transmitted using one or more of these CCEs, where each CCE can correspond to nine sets of four physical resource elements known as REGs. Four quadrature phase shift keying (QPSK) symbols can be mapped to each REG. The PDCCH can be transmitted using one or more CCEs, depending on the size of the DCI and the channel condition. There can be four or more different PDCCH formats defined in LTE with different numbers of CCEs (e.g., aggregation level, L=1, 2, 4, 8, or 16).

The RAN nodes 122 or RAN 120 can be configured to communicate with one another via interface 123. In implementations where the system is an LTE system, interface 124 can be an X2 interface. The X2 interface can be defined between two or more RAN nodes 122 (e.g., two or more eNBs/gNBs or a combination thereof) that connect to evolved packet core (EPC) or CN 130, or between two eNBs connecting to an EPC. In some implementations, the X2 interface can include an X2 user plane interface (X2-U) 126 and an X2 control plane interface (X2-C) 128. The X2-U can provide flow control mechanisms for user data packets transferred over the X2 interface and can be used to communicate information about the delivery of user data between eNBs or gNBs. For example, the X2-U can provide specific sequence number information for user data transferred from a master eNB (MeNB) to a secondary eNB (SeNB); information about successful in sequence delivery of PDCP packet data units (PDUs) to a UE 110 from an SeNB for user data; information of PDCP PDUs that were not delivered to a UE 110; information about a current minimum desired buffer size at the SeNB for transmitting to the UE user data; and the like. The X2-C can provide intra-LTE access mobility functionality (e.g., including context transfers from source to target eNBs, user plane transport control, etc.), load management functionality, and inter-cell interference coordination functionality.

Alternatively, or additionally, RAN 120 can be also connected (e.g., communicatively coupled) to CN 130 via a Next Generation (NG) interface as interface 124. The NG interface 124 can be split into two parts, a Next Generation (NG) user plane (NG-U) interface 126, which carries traffic data between the RAN nodes 122 and a User Plane Function (UPF), and the S1 control plane (NG-C) interface 128, which is a signaling interface between the RAN nodes 122 and Access and Mobility Management Functions (AMFs).

CN 130 can comprise a plurality of network elements 132, which are configured to offer various data and telecommunications services to customers/subscribers (e.g., users of UEs 110) who are connected to the CN 130 via the RAN 120. In some implementations, CN 130 can include an evolved packet core (EPC), a 5G CN, and/or one or more additional or alternative types of CNs. The components of the CN 130 can be implemented in one physical node or separate physical nodes including components to read and execute instructions from a machine-readable or computer-readable medium (e.g., a non-transitory machine-readable storage medium).

As shown, CN 130, application servers 140, and external networks 150 can be connected to one another via interfaces 134, 136, and 138, which can include IP network interfaces. Application servers 140 can include one or more server devices or network elements (e.g., virtual network functions (VNFs) offering applications that use IP bearer resources with CN 130 (e.g., universal mobile telecommunications system packet services (UMTS PS) domain, LTE PS data services, etc.). Application servers 140 can also, or alternatively, be configured to support one or more communication services (e.g., voice over IP (VOIP sessions, push-to-talk (PTT) sessions, group communication sessions, social networking services, etc.) for UEs 110 via the CN 130. Similarly, external networks 150 can include one or more of a variety of networks, including the Internet, thereby providing the mobile communication network and UEs 110 of the network access to a variety of additional services, information, interconnectivity, and other network features.

As shown, example network 100 can include an NTN that can comprise one or more satellites 160-1 and 160-2 (collectively, “satellites 160”). Satellites 160 can be in communication with UEs 110 via service link or wireless interface 162 and/or RAN 120 via feeder links or wireless interfaces 164 (depicted individually as 164-1 and 164). In some implementations, satellite 160 can operate as a passive or transparent network relay node regarding communications between UE 110 and the terrestrial network (e.g., RAN 120). In some implementations, satellite 160 can operate as an active or regenerative network node such that satellite 160 can operate as a base station to UEs 110 (e.g., as a gNB of RAN 120) regarding communications between UE 110 and RAN 120. In some implementations, satellites 160 can communicate with one another via a direct wireless interface (e.g., 166) or an indirect wireless interface (e.g., via RAN 120 using interfaces 164-1 and 164-2).

Additionally, or alternatively, satellite 160 can include a GEO satellite, LEO satellite, or another type of satellite. Satellite 160 can also, or alternatively pertain to one or more satellite systems or architectures, such as a global navigation satellite system (GNSS), global positioning system (GPS), global navigation satellite system (GLONASS), BeiDou navigation satellite system (BDS), etc. In some implementations, satellites 160 can operate as bases stations (e.g., RAN nodes 122) with respect to UEs 110. As such, references herein to a base station, RAN node 122, etc., can involve implementations where the base station, RAN node 122, etc., is a terrestrial network node and implementation, where the base station, RAN node 122, etc., is a non-terrestrial network node (e.g., satellite 160).

In an aspect, UE 110-1 can be configured to receive an indication of one or more first synchronization signal (SS)/physical block channel (PBCH) block (SSB) measurement timing configuration (SMTC) occasions and one or more second SMTC occasions for SSB measurements (e.g., from NTN 160-1 via interface 162, or other base station 120 via interface 114). The UE 110-1 can further determine whether a collision occurs between the one or more first SMTC occasions and the one or more second SMTC occasions, based on a proximity threshold of a proximity distance. For example, the proximity distance can be an MG proximity distance between a first measurement gap associated with the one or more first SMTC occasions and a second measurement gap associated with the one or more second SMTC occasions being less than or equal to the proximity threshold. Alternatively, or additionally, the proximity distance can include an SMTC proximity distance between SMTCs, or be between an MG and an SMTC. In response to the collision being deemed as occurring, the UE 110-1 can perform the SSB measurements in the one or more first SMTC occasions or the one or more second SMTC occasions.

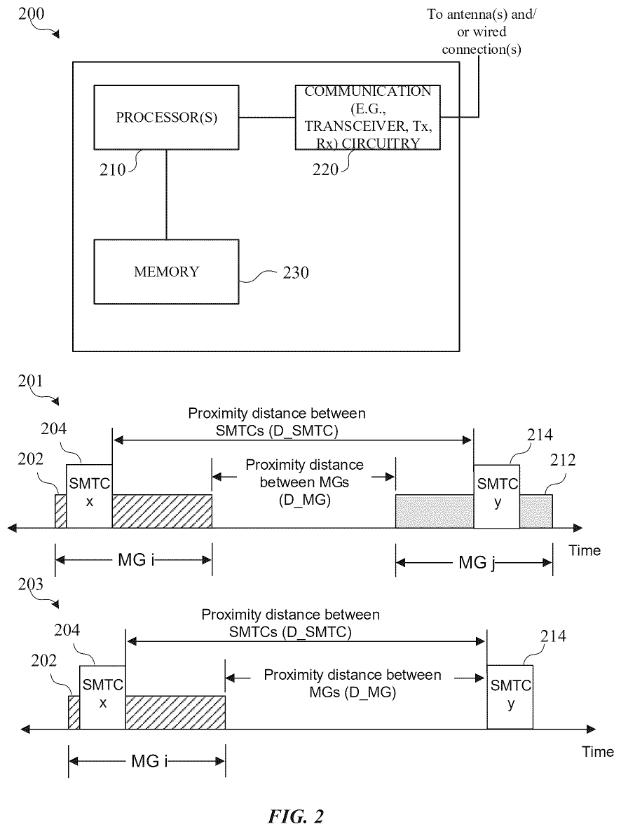

Referring to FIG. 2, illustrated is a block diagram of a UE device or other network device/component (e.g., V-UE/P-UE, IoT, gNB, eNB, or other participating network entity/component). The device 200 includes one or more processors 210 (e.g., one or more baseband processors) comprising processing circuitry and associated interface(s), transceiver circuitry 220 (e.g., comprising RF circuitry, which can comprise transmitter circuitry (e.g., associated with one or more transmit chains) and/or receiver circuitry (e.g., associated with one or more receive chains) that can employ common circuit elements, distinct circuit elements, or a combination thereof), and a memory 230 (which can comprise any of a variety of storage mediums and can store instructions and/or data associated with one or more of processor(s) 210 or transceiver circuitry 220).

Memory 230 (as well as other memory components discussed herein, e.g., memory, data storage, or the like) can comprise one or more machine-readable medium/media including instructions that, when performed by a machine or component herein cause the machine or other device to perform acts of a method, an apparatus or system for communication using multiple communication technologies according to aspects, embodiments and examples described herein. It is to be understood that aspects described herein can be implemented by hardware, software, firmware, or any combination thereof. When implemented in software, functions can be stored on or transmitted over as one or more instructions or code on a computer-readable medium (e.g., the memory described herein or other storage device). Computer-readable media includes both computer storage media and communication media including any medium that facilitates transfer of a computer program from one place to another. A storage media or a computer readable storage device can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or other tangible and/or non-transitory medium, that can be used to carry or store desired information or executable instructions. Any connection can be also termed a computer-readable medium.

Memory 230 can include executable instructions, and be integrated in, or communicatively coupled to, processor or processing circuitry 210. The executable instructions of the memory 230 can cause processing circuitry 210 to receive/process an indication or notification of one or more first SMTC occasions or SMTC windows and one or more second SMTC occasions for measuring resources. A (pre)determination whether a collision occurs between one or more first SMTC occasions and one or more second SMTC occasions can be executed by the processing circuitry 210 or via instructions of memory 230 based on a proximity threshold of a proximity distance. In response to the collision occurring, the processing circuitry 220, instructions of memory 230, or communication circuitry 220 can perform the measuring in either the one or more first SMTC occasions or the one or more second SMTC occasions, or in one MG or another one associated with the SMTCs, respectively. If a collision is not deemed to occur, then each of the MGs or SMTCs could be used for measuring. The proximity threshold of a proximity distance can be between different MGs, different SMTC windows/occasions or an MG and an SMTC, for example.

Current agreements are not necessarily clear about the proximity distance determining overlap for different processes 201 and 203. For example, signal measurement processes 201 for (pre)determining when a collision (overlap) is occurring includes SMTCs 204 and 214 inside different MGs 202, 212 having different distances than the distance than between the MGs 202, 212 themselves. SMTC x 204 is associated with MG i 202 and SMTC y 214 is associated with MG j 212. Even though the proximity distance between these two MGs 202, 212 are close to each other (e.g., the proximity distance D_MG is less than MG proximity threshold (e.g., 4 ms)), the proximity distance D_SMTCs between two SMTCs 204, 214 could still be greater than an SMTC proximity threshold (e.g., 4 ms, or other amount). In this case, there no certainty if SMTC x 204 and y 214 would be treated as colliding or non-colliding (where the UE 110 may only measure on one SMTC if two SMTCs are colliding).

Signal measurement processes 203 for (pre)determining when a collision (overlap) is occurring includes two group of SMTCs 204, 214, one SMTC 204 is associated with MG 202, but the other SMTC 214 is not associated with any MG. For example, SMTC x 204 is associated with MG i 204 and SMTC y 214 is not associated with any MG (SMTC without MG).

Even though the proximity distance between MG i 202 and SMTC y 214 are close to each other (e.g., the proximity distance D_MG_SMTC is less than proximity threshold), the proximity distance D_SMTCs between two SMTCs 204 and 214 can still be greater than SMTC proximity threshold (e.g., 4 ms). In this case it may be unclear if SMTC x 204 and y 214 shall be treated as colliding or non-colliding, where the UE 110 may only measure on one SMTC if two SMTCs are colliding or considered as overlapping.

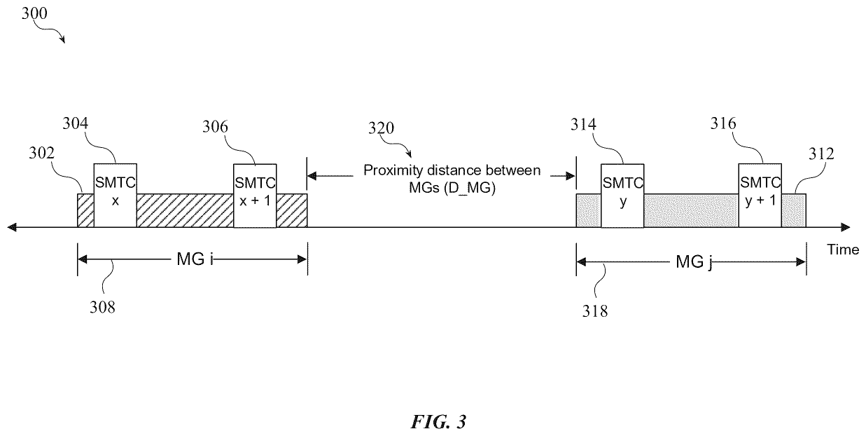

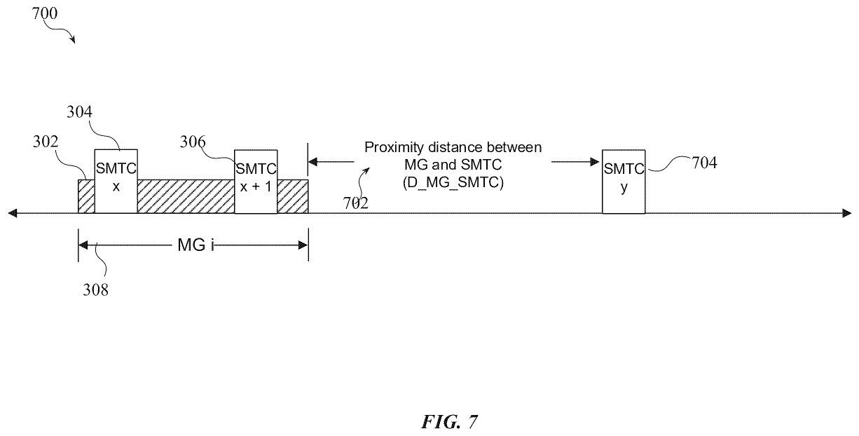

Referring briefly to FIG. 3 thru 10, illustrated are examples of signal measurement processes 300 for (pre)determining when a collision (overlap) is occurring between different measurement occasions for the UE to conduct RLM/RRM measurements of resources in accord with various aspects. While FIGS. 3 thru 6 illustrate example aspects for determining collision or overlap between different MGs associated with different SMTCs, FIGS. 7 thru 10 illustrate example aspects between an MG with SMTCs associated therewith and one or more SMTCs without an association to any MG.

Different measurement occasions can include different measurement gaps (MGs) 302, 312 (e.g., MG i, MG j), as illustrated in FIGS. 3 thru 6, with different SMTC occasions 304 thru 316. By determining the proximity of each measurement gap or SMTC occasion with respect to one another, a UE (e.g., UE 110, 200), such as an NTN UE, or other UE, can determine whether to measure at each MG/SMTC when no collision occurs, or only at one occasion (MG/SMTC) when a collision is determined as occurring. While FIGS. 3 thru 6 illustrate example aspects for determining collision or overlap between different MGs associated with different SMTCs, FIGS. 7 thru 10 illustrate example aspects between an MG with SMTCs associated therewith and one or more SMTCs without an association to any MG.

If the UE 110 considers measurement gaps 302 and 312 (or, SMTCs) to be overlapping (colliding), for example, then the UE 110 only measures within one measurement gap, or in a one-time instance or SMTC occasion; and thus, other periods have to be used to capture or realize the un-measured occasions for performing measurement(s). However, if measurement gaps 302 and 312 are not determined to be overlapping (colliding) based on a proximity distance threshold (e.g., 4 ms or the like), then the UE 110 can measure each measurement gap/SMTC occasion within a single periodicity, avoiding unnecessary measurements at a later time and reducing power consumption.

Two SMTC occasions 304 and 306, for example, can be defined as colliding (overlapping), if the two SMTC occasions 304 and 306 are at least partially overlapping in a time domain, or a particular proximity distance/minimum distance is less than a threshold amount from one another (e.g., about 3 ms, 4 ms, or other time). Alternatively, or additionally, two MG occasions 302 and 312 can be defined as colliding (overlapping) if the two MG occasions 302 and 312 are at least partially overlapping in a time domain or a particular proximity distance/minimum distance is less than a proximity distance threshold between one another (e.g., about 4 ms, or another time).

In 5G NR cell, signal measurements using SSBs, composed of synchronization signals (SSs) and a PBCH, can have a longer transmission periodicity than with a CRS. In particular, different SMTCs thus could be associated with different MGs, in which a total measurement gap duration 308 or 318 may be about 6 ms and the SMTC window itself being smaller (e.g., 1 ms, or other time amount) within the MG, for example. MG 302 and 312 include different SMTCs 304, 306 and 314, 316, respectively, and the SMTCs inside each of the MGs can have a different distance between one another than a distance between the MGs 302, 312 themselves. Thus, even though a proximity distance between the two MGs 302, 312 may indicate these MGs as overlapping (e.g., when a proximity distance D_MG 320 is less than or equal to an MG proximity threshold of about 4 ms), the proximity distance (D_SMTC) between two SMTCs could still be greater than an SMTC proximity threshold (e.g., 4 ms or the like). Thus, these SMTCs may not actually be considered overlapping or colliding, even though the MGs are. A UE may be unclear on whether SMTC 304 and SMTC 314 are to be treated as colliding or non-colliding. In other words, the UE 110 may not determine whether to measure on only one or more SMTCs, if two SMTCs are defined as colliding, when in some respects they may not be colliding and are able to be processed in a same periodicity. If a collision is determined, then the UE 110 only processes one measurement gap out of two MGs and in a one-time instance or SMTC occasion.

Due to a UE processing capability, the UE 110 utilizes some amount of time to receive a measurement occasion and to process these within a buffer/queue. If an additional measurement gap is being received afterwards, the UE 110 also utilizes a certain amount of time to be able to receive and process the additional measurement gap occasion. Thus, even though the two MGs 302 and 312, or in some aspects, an MG and SMTC, or two SMTCs, as described herein, are not necessarily physically overlapped in the time domain, as long as an interval or proximity distance between these two measurement gaps 302 and 312 remains small, the UE 110 could still define them as overlapping. Consequently, the UE 110 only processes one MG out of two and in a one-time instance or SMTC occasion when a collision or overlap condition is determined. Depending on the manner in which a proximity threshold is defined, opportunities to improve efficiency in timing and power can be further exploited.

In particular, proximity rule(s) can be defined by the UE 110 for determining whether two occasions are close to each other sufficiently and to consider that a collision (overlap) is occurring, or the occasions are far enough away from one another to be considered without a collision, and thus the UE 110 can accommodate processing/measuring of each MG/SMTC in a same period or periodicity. Various aspects include techniques for determining a collision/overlap between measurement occasions for measuring SSBs for RRM processes, especially for UEs such as NTN UEs, for example.

FIG. 3 illustrates an example where two different MG occasions 302 and 312 are signaled to the UE 110, each including different SMTCs 304, 306 and 314, 316, respectively. SMTC (x) 304 and SMTC (x+1) 306 are within MG 302, and SMTC (y) 314 and SMTC (y+1) 316 are within MG 312, for example.

In an aspect, when one or more sets of SMTCs fall within different MGs, the UE 110 can determine whether the two MGs 302, 312 collide according to a proximity rule based on a proximity distance of a proximity distance threshold 320, such as between a completion of MG 302 and a beginning of MG 312, for example. If the two MGs 302, 312 are within the proximity distance threshold based on the proximity distance 320, then the MGs 302 and 312 are determined to overlap or collide; thus, the SMTCs within one of the MGs can be considered as overlapping or colliding and not be measured, while one or more SMTCs in the other MG are measured for resources or SSBs.

In an example, if the two MGs 302 and 312 overlap based on the proximity distance being at, or below, a proximity threshold 320 (e.g., 4 ms), then at least one of SMTCs (x) and (x+1) 304 and 306 of MG 302 could be measured, while the SMTCs (y) and (y+1) 314 and 316 of MG 312 would not be used for measuring. Alternatively, at least one of the SMTCs 314 and 316 of MG 312 could be measured, and the SMTCs 304 and 306 of MG 302 not be used for measuring.

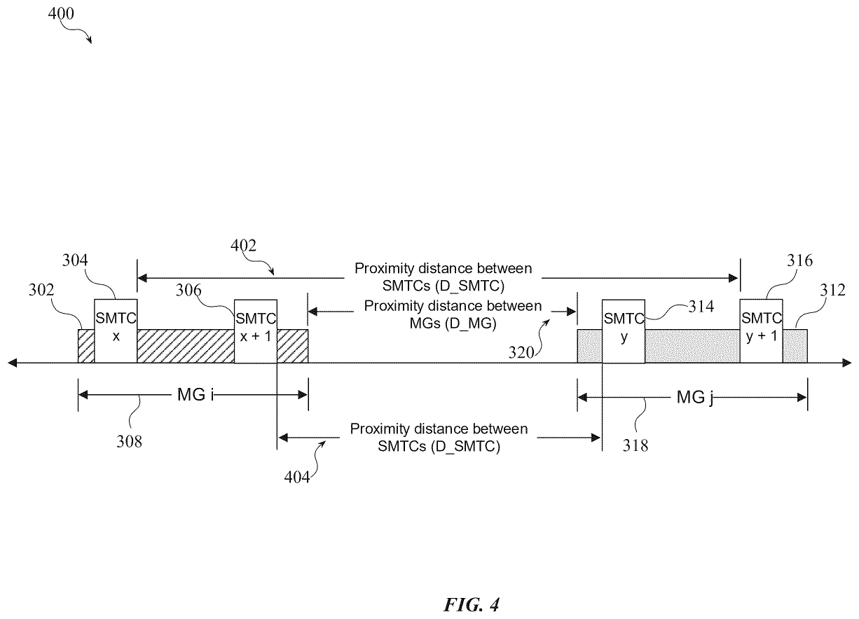

FIG. 4 illustrates another example of RRM processes 400 where two different MG occasions 302 and 312 are signaled to the UE 110 that each include different SMTCs 304, 306 and 314, 316, respectively. Similar to FIG. 3, SMTC (x) 304 and SMTC (x+1) 306 are within MG 302, and SMTC (y) 314 and SMTC (y+1) 316 are within MG 312, for example.

The UE 110 can receive SMTC occasions from the base station 120 and before conducting RRM measurements, (pre)determine whether the MGs 302 and 312 are overlapping based on a proximity distance 320 of a proximity distance threshold. If the MGs 308 and 318 satisfy the proximity distance threshold, for example, when a proximity distance D_MG 320 is less than or equal to an MG proximity threshold (e.g., 4 ms, or other amount), then the UE 110 can perform a second determination of SMTC proximity distance between each pair of SMTCs to determine whether each possible combination of SMTC pairs can be considered independently as colliding with one another or not. In other words, if the MGs 302 and 312, which are sequential to one another, are determined to collide or overlap, then a further determination of collision occurring or not can be processed between possible pairs of SMTCs. These pairs of SMTCs can be between SMTCs within a different MG, or even within the same MG. As such, in the present example of FIG. 4, because there are four SMTCs, twelve various SMTCs pairs would theoretically be possible for comparison.

In the example of FIG. 4, even though the two MGs 302 may have a distance 320 less than the MG proximity distance threshold and be determined as overlapping (colliding), the UE 110 does not necessarily determine that all the SMTCs within MG i 308 are overlapped with MG j 318. The UE 110 can further examine the SMTC occasion resources within each of the MGs 302, 312 by examining pairs of SMTCs among different MGs 302 312 to also determine whether these SMTC pairs collide among one another. For example, the UE 110 can compare SMTC (x) 304 paired with SMTC (y+1) 316 based on an SMTC based proximity distance 402 to determine if the SMTC proximity distance 402 between SMTC 304 and SMTC 316 is below the proximity distance threshold (an SMTC based proximity distance threshold). If the MG proximity distance 320 between MG 302 and MG 312 is smaller than or equal to the proximity distance threshold, but SMTC 304 and 312 are above the gap distance threshold according to an SMTC proximity distance (D_SMTC) 402, then the UE 110 can still operate as if these two SMTCs are not overlapped or colliding. Thus, for measurement purposes in RRM processes, SMTC 304 and SMTC 316 measurements can be performed in a same periodicity with each of SMTC 304 and 316 being used for measuring.

Likewise, the UE 110 can conduct operations similarly with other SMTC pairs in different MGs also. For example, an SMTC proximity distance 404 between SMTC 306 and 314 could be also less than the proximity distance threshold, which may be the same (e.g., 4 ms) or different than the proximity distance 320 for the MGs. Then the SMTCs could be determined as overlapping or colliding with one another. In response, the UE 110 could only measure with one of SMTC 306 or 314. If the other pair of SMTCs (e.g., SMTCs 304 and 316) across the same MGs 302 and 312, is not colliding/overlapping, while the pair of SMTCs 306 and 314 are colliding, then a greater number of SMTCs could be utilized for measuring resources or SSBs in a single periodicity or period, than just the proximity distance 320 being used to determine collision between the two MGs 302 and 312 alone.

In an aspect, potentially three SMTCs could be measured if one SMTC pair is colliding and another pair is not. Alternatively, both SMTCs of one SMTC pair not colliding could be measured, and no SMTCs of the other SMTC pair that is colliding. In another example, if all combinations of SMTC pairs are smaller than the SMTC proximity threshold and considered colliding, then only one SMTC out of four SMTCs 304, 306, 314, 316 for each periodicity could be measured, or one SMTC from one MG, for example. Various possibilities could be envisioned by these examples for potentially reducing unnecessary measurements at a later time, and reducing power consumption of the UE by enabling more measurement opportunities if possible within a same period of periodicity.

In an aspect, SMTCs in one MG 302 can be offset differently, and not equally spaced in comparison with SMTCs in the other MG 312. Thus, the time of an SMTC 304, 306 and time offset in the MG 302 can be configured independently. Thus, it can be advantageous for the UE 110 to check for each possible SMTC pair among one or more MGs to independently determine whether the SMTCs are below an SMTC proximity distance threshold (e.g., 402 or 404) or not. Independently evaluating the pairs of SMTCs can be especially advantageous when the proximity distance 320 between MGs 302 and 312 is considered at or below the threshold (e.g., about 4 ms) such that the MGs are considered colliding/overlapping, but some SMTC pairs still have SMTC proximity distances (e.g., 402) that are larger or outside of the proximity distance threshold (e.g., an SMTC based proximity distance threshold), such that these SMTC pairs do not collide (or overlap) and so each SMTC could be measured in the same period or periodicity.

In an aspect, an SMTC proximity distance threshold can be the same or different than the MG threshold. For SMTCs associated with different MGs, an SMTC proximity distance threshold can be configured as an MG proximity distance threshold plus twice a radio frequency (RF) tuning/retuning time, for example. Here, the SMTC proximity distance threshold is based on a UE processing capability for tuning from processing or receiving slots in between MGs to measuring within an MG. Where there are two MGs being evaluated, for example, this can add twice a tuning/retuning time to any particular threshold amount, such as the MG i 308 time or the MG j 318. For example, an RF tuning/retuning time could be about 1 ms, and the MG proximity distance threshold be 4 ms. Thus, the SMTC proximity distance threshold can be configured as about 6 ms, for example.

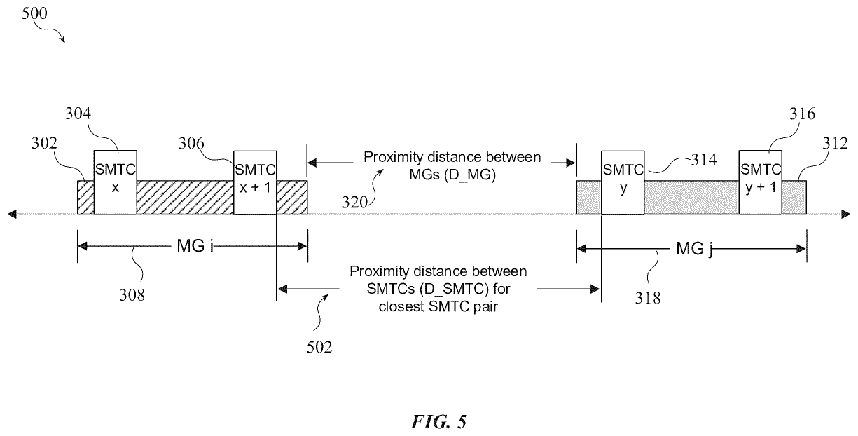

FIG. 5 illustrates another example of RRM processes 500 that include (pre)determining an overlap or collision condition in accordance with various aspects. Similarly to FIGS. 3-4, the RRM measurement processes 500 include two different MG occasions 302 and 312 being signaled to the UE 110, each including different SMTCs 304, 306 and 314, 316, respectively, for example. The UE 110 (pre)determines whether the MG proximity distance 320 is under the MG proximity distance threshold or not, and thus, colliding (or overlapping), or non-colliding/non-overlapping. If the MG proximity distance 320 is below or equal to the threshold, then the MGs 302 and 312 are determined to collide or overlap. If the MGs 302 and 312 do not overlap or collide (as non-colliding/non-overlapping) and the distance 320 is above the threshold, for example, then STMCs 304, 306, 314, 316 can each be used for measuring; however, if the MGs 302 and 312 do collide or overlap, then the UE 110 can further determine whether the SMTCs themselves collide based on an SMTC proximity distance 502 based on a closest pair (e.g., SMTC (x+1) 306 and SMTC (y) 314). Here, the only SMTC pair that the UE 110 checks to determine whether SMTCs are colliding is the two SMTCs that are determined as closest/shortest in distance to one another from among two groups of SMTCs or the two MGs 302, 312. If the closest SMTC pair (SMTC (x+1) 306 and SMTC (y) 314) is considered as colliding, where the proximity distance 502 is less than the SMTC proximity distance threshold between these SMTCs, then all the SMTCs 304, 306, 314, 316 can be treated as colliding SMTCs and only one MG 302 or 312 would be measured or only one SMTC within one MG, for example. If the closest SMTC pair (SMTC (x+1) 306 and SMTC (y) 314) is not colliding, and the proximity distance 502 is greater than the threshold, then at least SMTC 306 and SMTC 314 can be both be used for measuring; alternatively, each SMTC 304, 306, 314, 316 could be used for measuring, or any two in different MGs could be measured (e.g., SMC 304 and 316, or other SMTC pair from among both MGs).

As such, the UE 110 can be configured to compare the closest SMTCs from among different MGs 302 and 312 (e.g., SMTC (x+1) 306 and SMTC (y) 314), and if these are below the SMTC proximity distance threshold 502 and overlap, then the UE 110 can determine that SMTC (x) 304 and SMTC (y+1) 316 are overlapped also. In this manner, the closest SMTC pair can used to represent all SMTC pairs among two MGs for purposes of determining collision or overlap.

The UE 110 can operate to determine the closest pair of SMTCs either by a specific signaling, being predefined or by default pair of closest SMTCs to determine the distance between two SMTC groups. The default pair of closest SMTCs, for example, could be the last SMTC 306 of a first MG 302 and the first SMTC 314 of a second MG 312, the closest pair as measured among different SMTC pairs by the UE, or just sequentially in time among MGs as determined by the UE 110.

In an aspect, for SMTCs associated with different MGs, an SMTC proximity distance threshold can be configured as an MG proximity distance threshold plus twice a radio frequency (RF) tuning/retuning time. The SMTC proximity distance threshold can be based on a UE processing capability for tuning from processing or receiving slots in between MGs to measuring within an MG. If there are two MGs, for example, this can add twice a tuning/retuning time to any particular threshold amount, such as the MG i 308 time or the MG j 308.

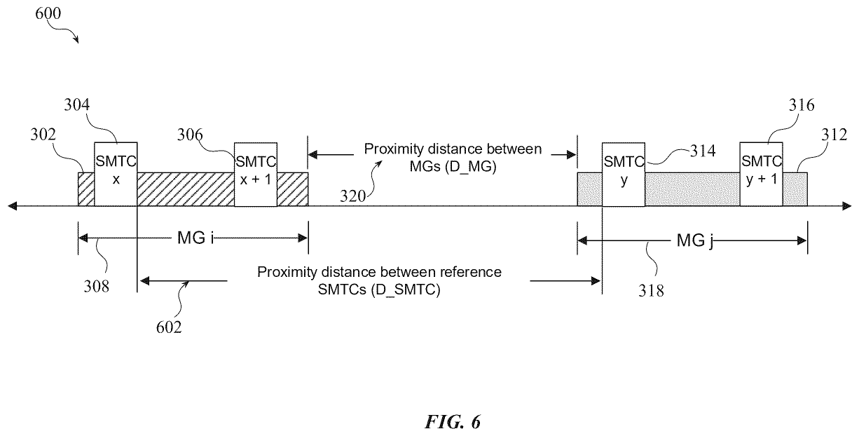

FIG. 6 illustrates another example of RRM processes 600 that includes determining an overlap or collision condition among measurement occasions in accordance with various aspects. Similarly to FIGS. 3-5, the RRM measurement processes 600 include two different MG occasions 302 and 312 being signaled to the UE 110, each including different SMTCs 304, 306 and 314, 316, respectively. The UE 110 initially determines whether the MG proximity distance 320 is under the MG proximity distance threshold or not, and thus, colliding (or overlapping), or non-colliding/non-overlapping. If MGs 302 and 312 are considered overlapping or colliding, then the UE 110 further determines whether an SMTC reference proximity distance 502 between a reference pair of SMTCs satisfies the SMTC proximity distance threshold (D_SMTC) or not. Thus, rather than the UE 110 automatically determining which SMTC can be used to determine an SMTC proximity distance 602, a reference SMTC can be signaled, predefined or initially determined. The reference SMTC can be the SMTC that can represent all the SMTCs within the same measurement gap, or within the same SMTC grouping for purposes of determining collision or overlap for RRM measurement processes.

In an aspect, the reference SMTC could be predefined based on the SMTC with a smallest offset from among the SMTCs of a measurement gap or SMTC grouping. Alternatively, or additionally, the reference SMTC can be based on the SMTC with the largest offset of the SMTCs of an MG or SMTC grouping. This offset is not necessarily the closest SMTC pair, but means that on the time domain in absolute timing each SMTC has a time offset and a periodicity associated therewith, which can be used for deriving the reference SMTC, for example. The offset is also called a time offset of an SMTC window/occasion. As such, the reference SMTC can be based on this offset, as the smallest or the largest offset, among each MG or an SMTC grouping. When configuring the SMTC window/occasion, the UE 110 identifies where the SMTC window is located on a time domain based on a periodicity (e.g., 40 ms, or other periodicity) and the time offset associated with the particular SMTC, which can vary from other SMTCs. The UE 110 locates the window according to the periodicity and the time offset of the SMTC window to locate the SMTC within the particular periodicity or period window. For example, SMTC (x) 304 can be a reference SMTC as predefined or signaled by the network or base station 120 for MG 302, while SMTC (y) 314 could be a reference SMTC among SMTCs of MG 312, and the reference SMTC(s) can be based on a time offset of the SMTC window.

In an aspect, the reference SMTC position, index or offset amount as smallest or largest among an SMTC group could be signaled. The reference SMTC could be signaled by RRC signaling, a higher layer signaling, or via a physical channel by the base station. The reference SMTC can be indicated by the network, and then the UE 110 can use this reference SMTC to determine if the two group of SMTCs inside the MGs 302 and 312 are overlapping or not.

In an aspect, the UE 110 can utilize an SMTC as the reference SMTC to be paired with any other SMTC within the same MG or in another MG 312. For example, based on whether the SMTC proximity distance between the reference SMTC (e.g., SMTC 304) and another SMTC of a different MG satisfies the SMTC proximity distance threshold, would determine whether that SMTC pair (e.g., SMTC 304 and another SMTC in MG 312) overlaps with one another, or whether all SMTCs of the two MGs overlap. In this manner, the reference SMTC could represent a reference for all SMTCs to be determined as overlapping or colliding among different MGs. Alternatively, or additionally, a reference SMTC from each MG (e.g., SMTC 304 and 314) could be signaled or indicated, so that the determination of whether a collision or overlap occurring between two reference SMTCs of the two MGs 302, 312 can be made based on whether the SMTC proximity distance 602 satisfies an SMTC.

As illustrated here, for SMTCs associated with different MGs, an SMTC proximity distance threshold can be configured as an MG proximity distance threshold plus twice a radio frequency (RF) tuning/retuning time. The SMTC proximity distance threshold can be based on a UE processing capability for tuning from processing or receiving slots in between MGs to measuring within an MG. If there are two MGs, for example, this can add twice a tuning/retuning time to any particular threshold amount, such as the MG i 308 time or the MG j 318.

FIG. 7 thru 10 further describe aspects between SMTCs 304, 306 associated with or within an MG 302 and SMTCs without being associated with any MG, for example. As such, two SMTC groups with one or more SMTCs can be determined, with one SMTC group being associated with an MG and the other without any association to an MG. In these examples, SMTC x can be associated with MG i and SMTC y is not associated with any MG (an SMTC without MG). Even though the proximity distance between MG i and SMTC y are close to each other (e.g., the proximity distance D_MG_SMTC is less than the proximity threshold), the proximity distance D_SMTCs between two SMTCs can still be greater than SMTC proximity threshold (e.g., 4 ms). In this case, it could be unclear to the UE 110 if SMTC x and y should be treated as colliding or non-colliding, in which case the UE 110 may only measure on one SMTC if two SMTCs are colliding). In each example, the UE 110 can determine whether there is more than one SMTC not associated with an MG that is within a certain grouping proximity of another SMTC. This can be determined based on a predefined distance or other grouping check so that any SMTC grouped together can be treated or represented as a whole for determinations of collision or colliding with SMTC(s) associated with an MG.

FIG. 7 illustrates an example of RRM processes 700 that include (pre)determining whether SMTCs associated with an MG and at least one other SMTC, not associated with an MG, are overlapping or colliding. A first MG 302 of MG i length 308 can include various SMTCs (e.g., SMTC 304 and SMTC 306, or other SMTCs) that may occur earlier or later than SMTC (y) 704. The UE 110 can determine whether the SMTCs 304, 306 of the MG 302 collide or overlap with SMTC (y) 704, which is not associated with any MG, based on a proximity distance 702 between the MG 302 and the SMTC (y) 704. If the proximity distance 702 satisfies a proximity distance threshold, then the SMTCs 304, 306 of MG 302 could be determined as colliding/overlapping with SMTC (y) 704. If the distance 702 is smaller or equal to the threshold, for example, then a collision/overlap occurs, in which case only one SMTC (referring also to an SMTC occasion/window/duration as used herein) is used for measuring. For example, SMTC (x) 304 and SMTC (x+1) 306 and SMTC (y) 704 would be treated as colliding and only one SMTC would be measured among these SMTCs 304, 306, 704. If the proximity distance 702 is greater than the threshold, for example, then at least SMTC (y) 704 and at least one SMTC 304, 306 of MG 302 can be used for measuring.

As illustrated here, for SMTCs associated with one MG and other one or more SMTCs without any association to an MG, a proximity distance threshold between the MG 302 with SMTCs and the other SMTC(s) with or without an MG can be equivalent to a proximity distance threshold between MGs or between SMTCs according to aspects herein.

In an aspect, SMTC (y) 704 can represent one SMTC or more SMTCs based on a grouping check or group determination that could be performed by UE 110 prior to determining whether a collision or overlap is occurring. Any SMTC considered falling within a grouping with SMTC (y) 704 could be treated the same as SMTC (y) 704 with respect to a collision or overlap being determined to occur. For example, SMTC (y) 704 could be a first SMTC outside of MG 302, while any SMTC that is considered a part an SMTC group with SMTC (y) 704 could be within a defined distance or proximity distance thereafter. In aspect, any SMTC that collides with SMTC (y) 704 or within a measurement gap threshold (e.g., 4 ms) could be determined as within a same grouping of SMTCs, which are also without any measurement gap. If any SMTC within this defined distance is with an MG, then it would not qualify as part of the grouping, or is farther than the define distance in the time domain. In another example, the distance could be 5 ms, 3 ms, or other distance from SMTC (y) 704.

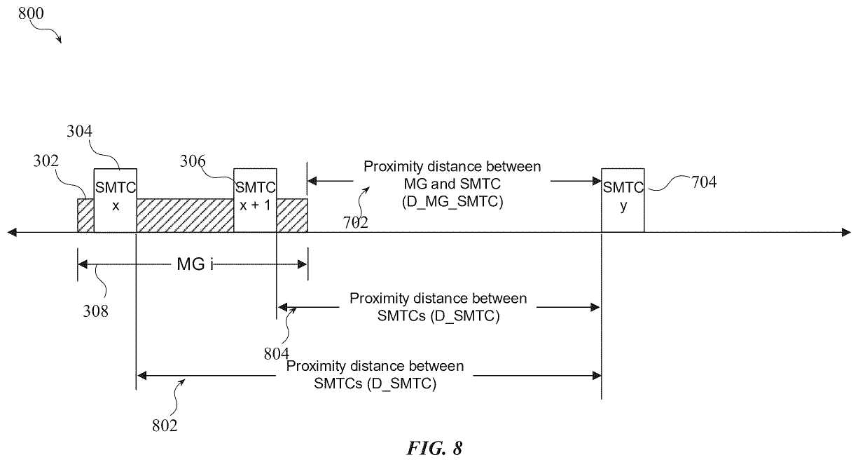

FIG. 8 illustrates an example of measurement processes 800 that include (pre)determining whether SMTCs associated with an MG and at least one other SMTC, not associated with an MG, are overlapping or colliding. A first MG i 302 of MG distance 308 can include various SMTCs (e.g., SMTC 304 and SMTC 306, or other SMTCs). The UE 110 can determine whether the SMITCs 304, 306 of the MG 302 collide or overlap with SMTC (y) 704, which is not associated with any MG, based on a proximity distance 702 that is between the MG 302 and the SMTC (y) 704. As discussed above, SMTC 704 could be one or more SMTCs based a grouping determination by the UE 110 and according to one or more criteria (e.g., a distance from SMTC 704). If the proximity distance satisfies a proximity distance threshold, then the SMTCs 304, 306 of MG 302 could be determined as colliding/overlapping with SMTC (y) 704.

In an aspect, the proximity distance threshold could be based on any one or more proximity distances between pairs of SMTCs, further utilizing distances 802 or 804, for example, if distance 702 between the MG 302 and SMTC 704 is determined to be at or below the threshold and considered as colliding or overlapping. First, UE 110 could check if MG 302 and SMTC 704 is below the proximity distance and if larger than an associated threshold, there is no need to check any further SMTC pair because all the SMTCs 304, 306 within MG 302 will not overlap with the SMTC 702. But, if the MG 302 boundary and SMTC 704 are below an associated threshold (e.g., 4 ms or the like), then the UE 110 can further double check within the MG 302 whether SMTCs 304, 306 are overlapped with SMTC 704 also. For example, the UE 110 can check SMTC (x) 304 and SMTC (y) 704 as an SMTC pair according to the proximity distance 802 there-between and a proximity distance threshold, and check SMTC (x+1) 306 and SMTC (y) 704 with proximity distance 804 and the threshold to evaluate whether any SMTC pairs overlap or not. If an SMTC pair does not overlap, then both SMTCs can be used for measuring; otherwise, only one SMTC is used for measuring from among that particular SMTC pair. Alternatively, or additionally, the threshold for SMTC pairs can be the same or different than the threshold for the MG and the SMTC without association to an MG.

For SMTCs associated with an MG and SMTC(s) without association to any MG, the SMTC proximity distance threshold for SMTC pairs can be configured as an MG proximity distance threshold (e.g., 4 ms, or other amount) plus a single radio frequency (RF) tuning/retuning time, for example. Here, the SMTC proximity distance threshold is based on a UE processing capability for tuning from processing or receiving slots in between MGs to measuring within only one MG, in contrast to when there are two MGs being evaluated, for example, which add twice a tuning/retuning time to any particular threshold amount. For example, an RF tuning/retuning time could be about 1 ms, and the MG proximity distance threshold be 4 ms. Thus, the SMTC proximity distance threshold can be configured as about 5 ms, for example, or other amount.

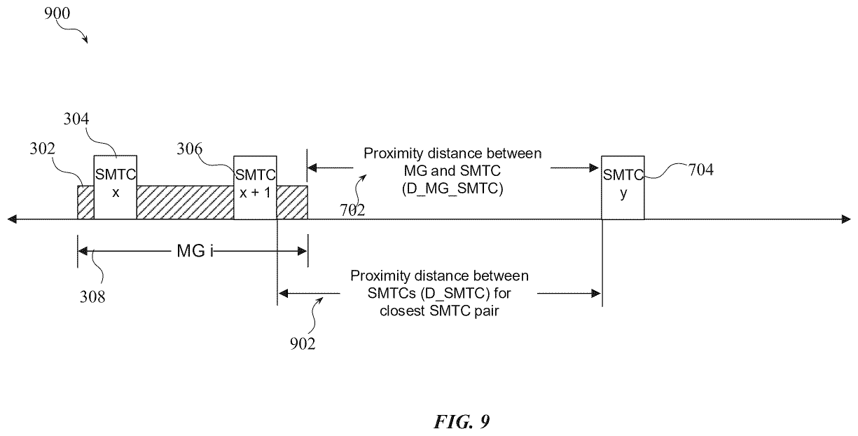

FIG. 9 illustrates an example of measurement processes 900 that include (pre)determining whether SMTCs associated with an MG and at least one other SMTC, not associated with an MG, are overlapping or colliding. A first MG i 302 of MG distance 308 can include various SMTCs (e.g., SMTC 304 and SMTC 306, or other SMTCs). The UE 110 can determine whether the SMTCs 304, 306 of the MG 302 collide or overlap with SMTC (y) 704, which is not associated with any MG, based on a proximity distance 702 that is between the MG 302 and the SMTC (y) 704. As discussed above, SMTC 704 could be one or more SMTCs based a grouping determination by the UE 110 and according to one or more criteria (e.g., a predefined proximity distance from SMTC 704, whether SMTC overlaps with any other SMTC not associated with an MG, or other criteria). If the proximity distance 902 satisfies a proximity distance threshold, then the SMTCs 304, 306 of MG 302 could be determined as colliding/overlapping with SMTC (y) 704.

In an aspect, the closest SMTC pair is used to determine whether the proximity distance is met or not. For example, SMTC (x+1) could only be used with and SMTC 704 to see if all the SMTCs 304, 306, or otherwise in the MG 302 overlap or collide with SMTC 704. If an overlap is determined, only one instance or SMTC could be measured in the period. If not overlap or collision is predicted to occur, then each of the SMTCs 304, 306, and 704 could be used for measuring.

In an example, if proximity distance D_MG_SMTC 702 between MG 302 and SMTC 704 is less than the proximity distance threshold, the UE 110 could use SMTC based proximity distance 902 to check whether the closest pair of SMTCs 306 and 704 overlap or not. If the closest SMTC pair inside and outside MGs has a proximity distance 902 less than SMTC proximity distance threshold, all the SMTCs in these MGs shall be treated as colliding SMTCs

For SMTCs inside and outside MG, the SMTC proximity distance threshold of SMTC proximity distance 902 can be represented as: MG proximity distance threshold+RF tuning/retuning time; in other words, an MG proximity distance threshold (e.g., about 4 ms) plus an RF tuning/retuning time (e.g., 1 ms or other smaller or larger amount).

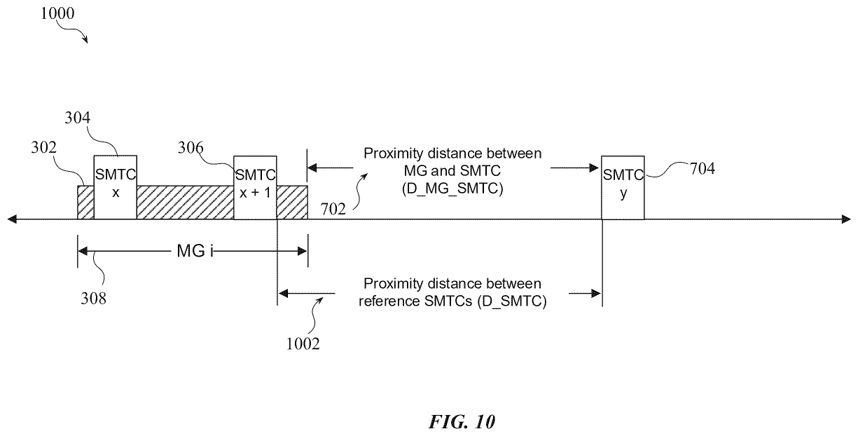

Referring to FIG. 10, illustrated is another example of measurement processes 1000 that include (pre)determining whether SMTCs associated with an MG and at least one other SMTC, not associated with an MG, are overlapping or colliding. Here, similar conditions exist as in other figures, except the proximity distance 1002 between reference SMTCs is used for determining an overlap between MG 302, SMTCs 304 and 306 with or between SMTC 704. If the distance 1002 between reference SMTC 306 associated with an MG 302 and SMTC 707 without any associated MG is above the proximity distance threshold, then each of the SMTCs 304, 306 and 702 could be used for measuring. This determination could be performed on condition that the proximity distance 702 is at or below a threshold, and MG 302 determined to overlap/collide with SMTC 704. Alternatively, only the reference SMTC is used without any condition for determining any overlap or collision.

In an aspect, the reference SMTC 1002 can be indicted by the network or chose based on the largest or smallest offset from among SMTCs of the MG 302 or an SMTC grouping represented by SMTC 704. Similar to FIG. 9, the SMTC proximity distance can be the MG proximity distance threshold plus one time RF tuning/retuning time.

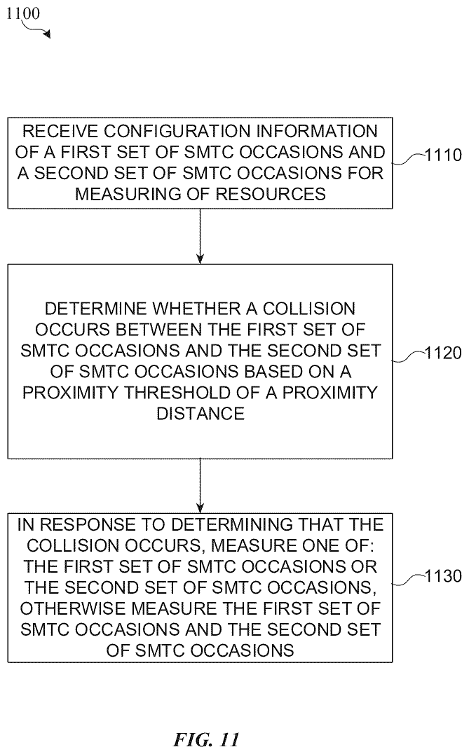

FIG. 11 illustrates an example process flow for (pre)determining overlap or collision among measuring occasions (e.g., MGs or SMTCs) as a part of RRM measurement process in accord with various aspects. Process flow 1100 initiates at 1110 with receiving configuration information of a first set of SMTC occasions and a second set of SMTC occasions for measuring of resources (e.g.., SSBs). At 1120, the process flow 1100 includes determining whether a collision or overlap occurs between the first set of SMTC occasions and the second set of SMTC occasions based on a proximity threshold of a proximity distance. At 1130, the process flow 1100 includes, in response to determining that the collision or overlap occurs, measuring one of: the first set of SMTC occasions or the second set of SMTC occasions, otherwise measuring both the first set of SMTC occasions and the second set of SMTC occasions where there is not collision or overlap.

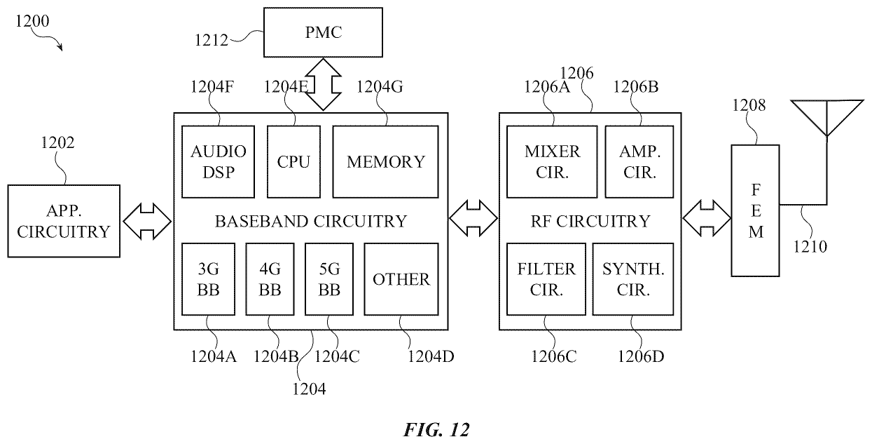

FIG. 12 illustrates example components of a device 1200 in accordance with some aspects. In some aspects, the device 1200 can include application circuitry 1202, baseband circuitry 1204, Radio Frequency (RF) circuitry 1206, front-end module (FEM) circuitry 1208, one or more antennas 1210, and power management circuitry (PMC) 1212 coupled together at least as shown. The components of the illustrated device 1200 can be included in a UE or a RAN node. In some aspects, the device 1200 can include fewer elements (e.g., a RAN node cannot utilize application circuitry 1202, and instead include a processor/controller to process IP data received from a CN such as 5GC 130 or an Evolved Packet Core (EPC)). In some aspects, the device 1200 can include additional elements such as, for example, memory/storage, display, camera, sensor (including one or more temperature sensors, such as a single temperature sensor, a plurality of temperature sensors at different locations in device 1200, etc.), or input/output (I/O) interface. In other aspects, the components described below can be included in more than one device (e.g., said circuitries can be separately included in more than one device for Cloud-RAN (C-RAN) implementations).

The application circuitry 1202 can include one or more application processors. For example, the application circuitry 1202 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1200. In some aspects, processors of application circuitry 1202 can process IP data packets received from the core network or base station.

The baseband circuitry 1204 can include circuitry such as, but not limited to, one or more single-core or multi-core processors. The baseband circuitry 1204 can include one or more baseband processors or control logic to process baseband signals received from a receive signal path of the RF circuitry 1206 and to generate baseband signals for a transmit signal path of the RF circuitry 1206. Baseband circuity 1204 can interface with the application circuitry 1202 for generation and processing of the baseband signals and for controlling operations of the RF circuitry 1206. For example, in some aspects, the baseband circuitry 1204 can include a third generation (3G) baseband processor 1204A, a fourth generation (4G) baseband processor 1204B, a fifth generation (5G) baseband processor 1204C, or other baseband processor(s) 1204D for other existing generations, generations in development or to be developed in the future (e.g., second generation (2G), sixth generation (6G), etc.). The baseband circuitry 1204 (e.g., one or more of baseband processors 1204A-D) can handle various radio control functions that enable communication with one or more radio networks via the RF circuitry 1206. In other aspects, some, or all of the functionality of baseband processors 1204A-D can be included in modules stored in the memory 1204G and executed via a Central Processing Unit 1204E. Memory 1204G can include executable components or instructions to cause one or more processors (e.g., baseband circuitry 1204) to perform aspects, processes or operations herein. The radio control functions can include, but are not limited to, signal modulation/demodulation, encoding/decoding, radio frequency shifting, etc. In some aspects, modulation/demodulation circuitry of the baseband circuitry 1204 can include Fast-Fourier Transform (FFT), precoding, or constellation mapping/demapping functionality. In some aspects, encoding/decoding circuitry of the baseband circuitry 1204 can include convolution, tail-biting convolution, turbo, Viterbi, or Low Density Parity Check (LDPC) encoder/decoder functionality. Aspects of modulation/demodulation and encoder/decoder functionality are not limited to these examples and can include other suitable functionality in other aspects.

In some aspects, the baseband circuitry 1204 can include one or more audio digital signal processor(s) (DSP) 1204F. The audio DSP(s) 1204F can include elements for compression/decompression and echo cancellation and can include other suitable processing elements in other aspects. Components of the baseband circuitry can be suitably combined in a single chip, a single chipset, or disposed on a same circuit board in some aspects. In some aspects, some, or all of the constituent components of the baseband circuitry 1204 and the application circuitry 1202 can be implemented together such as, for example, on a system on a chip (SOC).

In some aspects, the baseband circuitry 1204 can provide for communication compatible with one or more radio technologies. For example, in some aspects, the baseband circuitry 1204 can support communication with a NG-RAN, an evolved universal terrestrial radio access network (EUTRAN) or other wireless metropolitan area networks (WMAN), a wireless local area network (WLAN), a wireless personal area network (WPAN), etc. Aspects in which the baseband circuitry 1204 is configured to support radio communications of more than one wireless protocol can be referred to as multi-mode baseband circuitry.

RF circuitry 1206 can enable communication with wireless networks using modulated electromagnetic radiation through a non-solid medium. In various aspects, the RF circuitry 1206 can include switches, filters, amplifiers, etc. to facilitate the communication with the wireless network. RF circuitry 1206 can include a receive signal path which can include circuitry to down-convert RF signals received from the FEM circuitry 1208 and provide baseband signals to the baseband circuitry 1204. RF circuitry 1206 can also include a transmit signal path which can include circuitry to up-convert baseband signals provided by the baseband circuitry 1204 and provide RF output signals to the FEM circuitry 1208 for transmission.

In aspects, any one or more of baseband processors 1204A thru 1204F as processing circuitry of baseband circuitry 1204, along or integrated in combination, can be configured to process or receive configuration information of a first set (one or more) of SMTC) occasions and a second set of SMTC occasions for measuring of resources (e.g., SSBs). A determination can be made as to whether a collision occurs between the first set of SMTC occasions and the second set of SMTC occasions based on a proximity threshold of a proximity distance. In response to determining that the collision occurs, measure one of: the first set of SMTC occasions or the second set of SMTC occasions, otherwise the processing circuitry (e.g., the baseband processor or other circuitry) can measure the first set of SMTC occasions and the second set of SMTC occasions.

While the methods described within this disclosure are illustrated in and described herein as a series of acts or events, it will be appreciated that the illustrated ordering of such acts or events are not to be interpreted in a limiting sense. For example, some acts can occur in different orders and/or concurrently with other acts or events apart from those illustrated and/or described herein. In addition, not all illustrated acts can be required to implement one or more aspects or embodiments of the description herein. Further, one or more of the acts depicted herein can be carried out in one or more separate acts and/or phases. Reference can be made to the figures described above for ease of description. However, the methods are not limited to any particular embodiment, aspect or example provided within this disclosure and can be applied to any of the systems/devices/components disclosed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure is described with reference to attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can be also a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

As used herein, the term “circuitry” can refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some embodiments, the circuitry can be implemented in, or functions associated with the circuitry can be implemented by, one or more software or firmware modules. In some embodiments, circuitry can include logic, at least partially operable in hardware.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units.

Examples (embodiments) can include subject matter such as a method, means for performing acts or blocks of the method, at least one machine-readable medium including instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to embodiments and examples described herein.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communications media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal. In the alternative, processor and storage medium can reside as discrete components in a user terminal. Additionally, in some aspects, the processes and/or actions of a method or algorithm can reside as one or any combination or set of codes and/or instructions on a machine-readable medium and/or computer readable medium, which can be incorporated into a computer program product.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature can have been disclosed with respect to only one of several implementations, such feature can be combined with one or more other features of the other implementations as can be desired and advantageous for any given or particular application.

1. A User Equipment (UE) comprising:
at least one memory;
processing circuitry, coupled to the at least one memory, configured to cause the UE to:
receive indication of a first synchronization signal (SS)/physical block channel (PBCH) block (SSB) measurement timing configuration (SMTC) occasion and a second SMTC occasion for SSB measurement;
determine whether a collision occurs between the first SMTC occasion and the second SMTC occasion or between the first SMTC occasion and a measurement gap; and
in response to the collision occurring, perform the SSB measurement in the first SMTC occasion or the second SMTC occasion.

2. The UE of claim 1, wherein determining whether the collision occurs is based on at least one of: a proximity threshold of a proximity distance or at least a partial overlap in a time domain, between the first SMTC occasion and the second SMTC occasion or between the first SMTC occasion and the measurement gap.

3. The UE of claim 2, wherein determining whether the collision occurs is based on the proximity distance being between a first measurement gap associated with the first SMTC occasion and a second measurement gap, or between the first measurement gap and the second SMTC occasion associated with the second measurement gap, being less than or equal to the proximity threshold, and the processing circuitry is further configured to cause the UE to:
in response to determining that the collision is occurring based on the proximity distance, determine further whether an SMTC based proximity distance satisfies an SMTC proximity distance threshold between the first SMTC occasion and the second SMTC occasion.

4. The UE of claim 3, wherein the processing circuitry is further configured to cause the UE to:
determine the SMTC based proximity distance between a first plurality of SMTC occasions that are associated with different measurement gaps including the first measurement gap and the second measurement gap; and
determine the SMTC based proximity distance between a second plurality of SMTC occasions that are associated with the different measurement gaps.

5. The UE of claim 4, wherein the first plurality of SMTC occasions comprises a first SMTC occasion within the first measurement gap and a first SMTC occasion within the second measurement gap, and the second plurality of SMTC occasions comprises a second SMTC occasion within the first measurement gap and a second SMTC occasion within the second measurement gap, wherein the first plurality of SMTC occasions are a father distance, or a same distance, from one another than the second plurality of SMTC occasions.

6. The UE of claim 4, wherein the processing circuitry is further configured to cause the UE to:
measure one SMTC occasion of the first plurality of SMTC occasions in response to the SMTC based proximity distance between the first plurality of SMTC occasions satisfying the SMTC proximity distance threshold; and
measure each SMTC occasion of the second plurality of SMTC occasions, in response to the SMTC based proximity distance between the second plurality of SMTC occasions not satisfying the SMTC proximity distance threshold and no collision occurring.

7. The UE of claim 3, wherein the processing circuitry is further configured to cause the UE to:
in response to determining that the collision is occurring based on the proximity distance, determine whether an SMTC based proximity distance satisfies an SMTC proximity distance threshold between a first pair of SMTC occasions associated with different measurement gaps comprising the first measurement gap and the second measurement gap, wherein the first pair of SMTC occasions comprises SMTC occasions that are closer to one another than a second pair of SMTC occasions associated with the different measurement gaps.

8. The UE of claim 7, wherein the processing circuitry is further configured to cause the UE to:
in response to the SMTC based proximity distance being less than or equal to the SMTC proximity distance threshold, determine that both the first pair of SMTC occasions and the second pair of SMTC occasions collide.

9. The UE of claim 3, wherein the processing circuitry is further configured to cause the UE to:
in response to determining that the collision is occurring based on the proximity distance, determine whether a pair of reference SMTC occasions, as indicated by an offset or other indication received from a network, comprise an SMTC based proximity distance that satisfies an SMTC proximity distance threshold; and
in response to the pair of reference SMTC occasions being less than or equal to the SMTC proximity distance threshold, determine that SMTC occasions in both the first measurement gap and the second measurement gap collide.

10. The UE of claim 1, wherein
the determination of the collision is based on a proximity distance between the first SMTC occasion and the measurement gap being less than or equal to a proximity threshold.

11. The UE of claim 10, wherein processing circuitry is further configured to cause the UE to:
in response to the collision occurring, determine a SMTC based proximity distance between the first SMTC occasion and the second SMTC occasion based on the SMTC based proximity distances.

12. The UE of claim 10, wherein processing circuitry is further configured to cause the UE to:
in response to determining that the collision is occurring based on the proximity distance, determine whether an SMTC based proximity distance satisfies an SMTC proximity distance threshold between a closest first pair of SMTC occasions associated with the first SMTC occasion and the second SMTC occasion, wherein the closest first pair of SMTC occasions comprises SMTC occasions that are closer to one another than a second pair of SMTC occasions associated with the first SMTC occasion, and wherein the second SMTC occasion comprises at least one of: a second SMTC occasion or a plurality of second SMTC occasions within a distance of one another.

13. The UE of claim 10, wherein processing circuitry is further configured to cause the UE to:
in response to determining that the collision is occurring based on the proximity distance, determine whether a pair of reference SMTC occasions between the first SMTC occasion and the second SMTC occasion, as indicated by an offset or an indication received from a network, comprise an SMTC based proximity distance that satisfies an SMTC proximity distance threshold; and
in response to the pair of reference SMTC occasions being less than or equal to the SMTC proximity distance threshold, determine that the first SMTC occasion and the second SMTC occasion collide.

14. The UE of claim 10, wherein the proximity threshold comprises an SMTC proximity threshold that comprises a measurement gap proximity distance threshold plus a single amount of radio frequency tuning time associated with the measurement gap.

15. A method comprising:
receiving, via processing circuitry, indication of a first set of synchronization signal (SS)/physical block channel (PBCH) block measurement timing configuration (SMTC) occasions and a second set of SMTC occasions for measuring of resources;
determine whether a collision occurs based on at least one of: a proximity threshold of a proximity distance being satisfied or an overlap there-between in a time domain;
in response to the collision occurring, perform the measuring in the first set of SMTC occasions or the second set of SMTC occasions.

16. The method of claim 15, wherein the proximity distance is a distance between a SMTC occasion and a measurement gap, and the collision is determined to occur when the distance is equal to or less than 4 ms.

17. The method of claim 15, further comprising:
in response to determining that the collision is occurring based on the proximity distance between a first measurement gap with the first set of SMTC occasions and a second measurement gap with the second set of SMTC occasions or the second set of SMTC occasions, determine whether an SMTC based proximity distance satisfies an SMTC proximity distance threshold between one or more pairs of the first set of SMTC occasions and the second set of SMTC occasions.

18. The method of claim 17, wherein if the proximity distance is between the first measurement gap and the second measurement gap, the SMTC proximity distance threshold comprises a measurement gap proximity distance threshold plus twice a radio frequency tuning time associated with the first measurement gap and the second measurement gap, and if the proximity distance is between the first measurement gap and the second set SMTC occasions, the SMTC proximity distance threshold comprises the measurement gap proximity distance threshold plus a radio frequency tuning time associated with the first measurement gap.

19. The method of claim 17, wherein the one or more pairs comprise a closest pair of SMTC occasions between the first set of SMTC occasions and the second set of SMTC occasions.

20. A baseband processor comprising:
processing circuitry configured to:
receive configuration information of a first set of synchronization signal (SS)/physical block channel (PBCH) block measurement timing configuration (SMTC) occasions and a second set of SMTC occasions for measuring of resources;
determine whether a collision occurs between the first set of SMTC occasions and the second set of SMTC occasions or between the first set of SMTC occasions and a measurement gap occasion; and
in response to determining that the collision occurs, measure one of: the first set of SMTC occasions or the second set of SMTC occasions, otherwise measure the first set of SMTC occasions and the second set of SMTC occasions.

21-23. (canceled)
